(19) United States
(12) Patent Application Publication
(10) Pub. No.: US 2015/0234424 A1
(43) Pub. Date: Aug. 20, 2015

(54) OPERATION SYSTEM

(71) Applicant: HONDA MOTOR CO., LTD., Tokyo (JP)

(72) Inventor: Nobuteru Takeshi, Wako-shi (JP)

(73) Assignee: HONDA MOTOR CO., LTD., Tokyo (JP)

(21) Appl. No.: 14/621,800

(22) Filed: Feb. 13, 2015

(30) Foreign Application Priority Data
Feb. 18, 2014 (JP) 2014-028724

(51) Int. Cl. G06F 1/16; G06F 3/041

(52) U.S. Cl. CPC G06F 1/16; G06F 3/0412; G06F 3/0416

(57) ABSTRACT

An operation system includes a sensor unit having a structure with protrusions or depressions on its surface, a display unit, and a selecting unit. The sensor unit detects a position at which a contact body touches the surface and outputs a position signal indicating the detected position. The display unit displays an image corresponding to the surface of the sensor unit and including operation key images. The selecting unit selects an operation key image corresponding to the position of the contact body from the operation key images displayed on the display unit. The position of the contact body at which selection of the operation key image is switched differs between the case where a continuous change in the position signal indicates a first direction and the case where the continuous change in the position signal indicates a second direction which is opposite to the first direction.

### CROSS REFERENCES TO RELATED APPLICATIONS

The present application claims priority under 35 U.S.C. §119 to Japanese Patent Application No. 2014-028724, filed Feb. 18, 2014, entitled “Operation System.” The contents of this application are incorporated herein by reference in their entirety.

### TECHNICAL FIELD

The present disclosure relates to an operation system.

### BACKGROUND

A sensor such as a touch pad which receives an operation performed by an operator may be disposed on a steering wheel or a center console having an operation screen for operating equipment installed in an automobile (see Japanese Unexamined Patent Application Publication No. 2006-347215). An operation system receives a signal according to an operation performed by an operator from the sensor, and controls the equipment installed in an automobile in accordance with the signal.

### SUMMARY

However, in the operation system of the related art, an operator needs to operate the sensor while watching the operation screen. Even in the case where a structure with protrusions and depressions which can be touched by the operator with his/her finger is simply formed on the surface of the sensor so that the operator can operate the operation screen by touch without watching the operation screen, the operation system has a problem of low operability.

The present application describes an operation system having improved operability. In the following explanation of the exemplary embodiment, specific elements with their reference numerals are indicated by using brackets. These specific elements are presented as mere examples in order to facilitate understanding, and thus, should not be interpreted as any limitation to the accompanying claims.

According to a first aspect of the embodiment, there is provided an operation system (for example, an operation system 1 in the embodiments) including a sensor unit (for example, a sensor unit 10a, 10b, or 10c in the embodiments), a display unit (for example, a display unit 30 in the embodiments), and a selecting unit (for example, a selecting unit 23 in the embodiments). The sensor unit has a structure with protrusions and depressions on a surface thereof. The sensor unit detects a position at which a contact body (for example, an operator's finger in the embodiments) touches the surface and outputs a position signal indicating the detected position of the contact body. The display unit displays an image corresponding to the surface of the sensor unit and including a plurality of operation key images. The selecting unit selects an operation key image corresponding to the position of the contact body from the plurality of operation key images displayed on the display unit. The position of the contact body at which selection of the operation key image is to be switched differs between a case in which a continuous change in the position signal indicates a first direction and a case in which the continuous change in the position signal indicates a second direction which is opposite to the first direction.

According to a second aspect of the embodiment, the sensor unit (for example, the sensor unit 10a, 10b, or 10c in the embodiments) may have a structure in which protrusion portions (for example, protrusion portions 11 in the embodiments) are arranged in a matrix on the surface. In the case where the continuous change in the position signal indicates a direction from a first protrusion portion to a second protrusion portion among the protrusion portions, even when the position signal indicates a predetermined area of the second protrusion portion, the selecting unit (for example, the selecting unit 23 in the embodiments) may continue selecting the operation key image which was selected when the position signal indicated the first protrusion portion. In the case where the continuous change in the position signal indicates a direction from the second protrusion portion to the first protrusion portion, even when the position signal indicates the predetermined area of the first protrusion portion, the selecting unit may continue selecting the operation key image which was selected when the position signal indicated the second protrusion portion.

According to a third aspect of the embodiment, when the position of the contact body is moved from a position other than the protrusion portions to a protrusion portion, the selecting unit (for example, the selecting unit 23 in the embodiments) may switch selection of the operation key image at a position based on the highest height position in the predetermined area of the protrusion portion.

According to a fourth aspect of the embodiment, when the position of the contact body is moved from a position other than the protrusion portions to a protrusion portion, the selecting unit (for example, the selecting unit 23 in the embodiments) may switch selection of the operation key image at a position ahead of where the contact body has passed through the highest position in the predetermined area of the protrusion portion.

According to a fifth aspect of the embodiment, in the sensor unit (for example, the sensor unit 10a, 10b, or 10c in the embodiments), a length of a clearance between adjacent protrusion portions among the protrusion portions may differ between a line direction and a column direction.

According to a sixth aspect of the embodiment, the sensor unit (for example, the sensor unit 10a, 10b, or 10c in the embodiments) may have the protrusion portions, the number of which is more than the number of operation key images displayed on the display unit (for example, the display unit 30 in the embodiments).

According to a seventh aspect of the embodiment, the sensor unit (for example, the sensor unit 10a, 10b, or 10c in the embodiments) may be capable of detecting a pressing operation performed on at least a part of the surface. When the sensor unit detects the pressing operation, the selecting unit (for example, the selecting unit 23 in the embodiments) may perform a process corresponding to the operation key image selected as the operation key image corresponding to the position of the contact body.

According to one aspect, the selecting unit causes the position of a contact body for switching selection of an operation key image to differ between the case in which the continuous change in the position signal indicates the first direction and the case in which the continuous change in the position signal indicates the second direction which is opposite to the first direction, achieving improved operability.

### BRIEF DESCRIPTION OF THE DRAWINGS

The advantages of the disclosure will become apparent in the following description taken in conjunction with the following drawings.

FIG. 1 is a diagram illustrating an exemplary configuration of an operation system according to a first embodiment.

FIG. 2 is a diagram illustrating exemplary operations on a sensor unit according to the first embodiment.

FIG. 3 is a front view of an exemplary configuration of the sensor unit according to the first embodiment.

FIG. 4 is a side view of an exemplary configuration of the sensor unit according to the first embodiment.

FIG. 5 is a side view of another exemplary configuration of the sensor unit according to the first embodiment.

FIG. 6 is a conceptual diagram illustrating shape information according to the first embodiment.

FIG. 7 is a diagram illustrating an example of a character input keyboard image and a cursor image according to the first embodiment.

FIG. 8 is a diagram illustrating a second example of the cursor image which has moved, according to the first embodiment.

FIG. 9 is a diagram illustrating an example of a process-selection keyboard image and a cursor image according to the first embodiment.

FIG. 10 is a diagram illustrating an example of the cursor image which has moved, according to the first embodiment.

FIG. 11 is a diagram illustrating an exemplary relationship between a force with which a finger is caught and a threshold, according to the first embodiment.

FIG. 12 is a diagram illustrating an exemplary relationship between a selected operation key image and a threshold, according to the first embodiment.

FIG. 13 is a state transition diagram of the operation system according to the first embodiment.

FIG. 14 is a front view of an exemplary configuration of a sensor unit according to a second embodiment.

FIG. 15 is a diagram illustrating an example of positions corresponding to positions of a contact body, according to the second embodiment.

FIG. 16 is a diagram illustrating an exemplary configuration of an operation system according to a third embodiment.

FIG. 17 is a front view of an exemplary configuration of a sensor unit according to the third embodiment.

FIG. 18 is a side view of an exemplary configuration of the sensor unit according to the third embodiment.

FIG. 19 is a side view of another exemplary configuration of the sensor unit according to the third embodiment.

### DESCRIPTION OF THE PREFERRED EMBODIMENTS

Referring to the drawings, embodiments of an operation system according to the present disclosure will be described below.

### First Embodiment

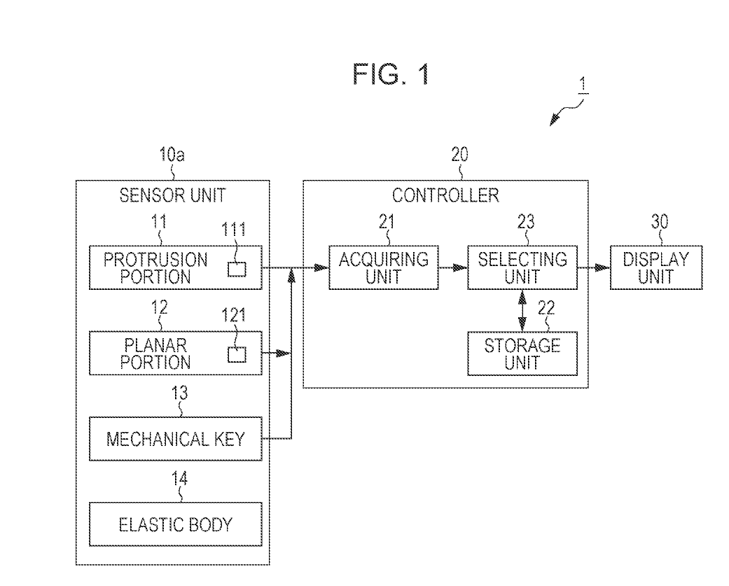

FIG. 1 is a diagram illustrating an exemplary configuration of an operation system 1 according to a first embodiment. The operation system 1 controls electronic equipment such as equipment installed in an automobile in accordance with a signal according to an operation performed by an operator. The operation system 1 is mounted, for example, on a vehicle. The operation system 1 includes a sensor unit 10a, a controller 20, and a display unit 30.

The sensor unit 10a has multiple protrusion portions 11 arranged in a matrix and a planar portion 12, on the surface thereof as a structure with unevenness such as protrusions and depressions. The protrusion portions 11 may be depression portions. That is, on the surface of the sensor unit 10a, there are positions within the protrusion portions 11 and positions outside of the protrusion portions 11. Each of the protrusion portions 11 includes a touch sensor 111. The protrusion portion 11 is capable of detecting a position which is located on the surface of the sensor unit 10a and at which a contact body touches the protrusion portion 11, on the basis of a change in the electrostatic capacity of the touch sensor 111, a change in the applied pressure, or the like. The planar portion 12 includes a touch sensor 121. The planar portion 12 is capable of detecting a position which is located on the surface of the sensor unit 10a and at which a contact body touches the planar portion 12, on the basis of a change in the electrostatic capacity of the touch sensor 121, a change in the applied pressure, or the like. The contact body is, for example, an operator's finger. The protrusion portions 11 and the planar portion 12 output a position signal indicating the detected position of the contact body to the controller 20.

The sensor unit 10a further includes a mechanical key 13 and an elastic body 14. The mechanical key 13 is capable of detecting a position which is located on the surface of the sensor unit 10a and at which at least a part of the surface of the sensor unit 10a is pressed. The mechanical key 13 outputs a press signal which indicates the detected position of the pressing operation, to the controller 20. The sensor unit 10a is disposed, for example, on the center console or the steering wheel of a vehicle by using the elastic body 14.

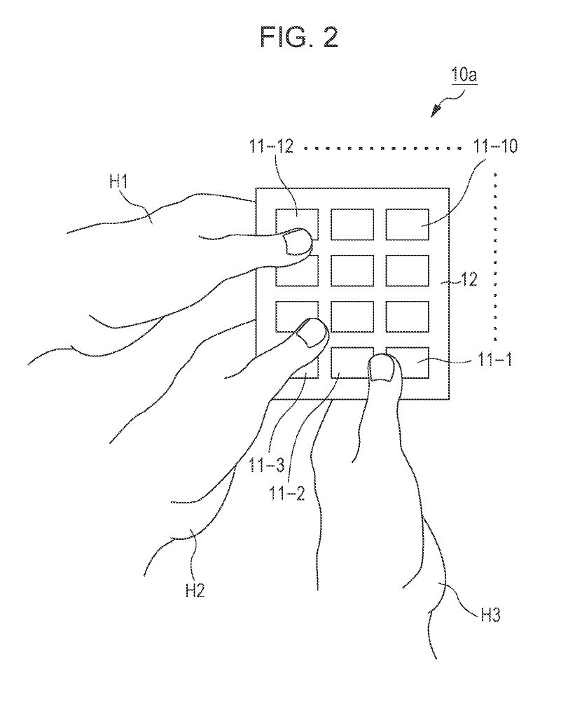

FIG. 2 is a diagram illustrating exemplary operations on the sensor unit 10a, according to the first embodiment. The size of the surface of the sensor unit 10a is such a predetermined size that, for example, the operator's thumb may reach the ends of the surface without any effort. The height of a protrusion portion 11 is a predetermined height which may be sensed by an operator's finger. In FIG. 2, the protrusion portions 11 are arrayed, for example, in a 4×3 matrix.

As illustrated by using hands H1, H2, and H3 in FIG. 2, an operator may touch the surface of the sensor unit 10a in any direction. The operator may also touch the surface of the sensor unit 10a with any finger of the operator. The operator performs an operation of intentional sliding his/her finger while touching the surface of the sensor unit 10a (hereinafter referred to as a “slide operation”). The operator may slide his/her finger on the surface of the sensor unit 10a in any direction only by changing the direction in which his/her hand holds the sensor unit 10a, while the position of his/her hand or finger is stabilized. Thus, the operator may easily operate the sensor unit 10a.

A coordinate system in which the column direction is set to the x axis, and in which the line direction is set to the y axis is defined below for the sake of convenience. The normal direction with respect to the plane is set to the z axis.

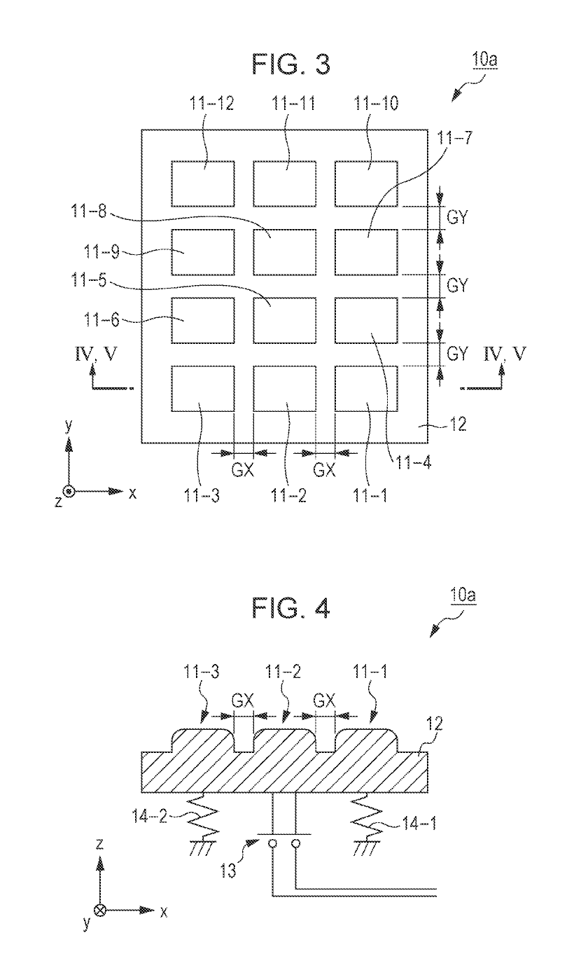

FIG. 3 is a front view of an exemplary configuration of the sensor unit 10a according to the first embodiment. In FIG. 3, the protrusion portions 11 are arranged, for example, in a 4×3 matrix. The protrusion portions 11 may be depression portions. The shape of a protrusion portion 11 is such a shape that the boundary portion is differently sensed, such as a rectangle, a rounded rectangle, or a circle. Also in a portion other than the boundary portion of a protrusion portion 11, the contour which is smooth enables an operator to grasp the position of his/her finger easily.

Among clearances between adjacent ones among the protrusion portions 11-1 to 11-12 which are arranged in a matrix, the length GY of a clearance in the line direction of the protrusion portions 11 is, for example, about 1 to 3 mm. In contrast, the length GX of a clearance in the column direction of the protrusion portions 11 is, for example, about 5 mm. Thus, the length of a clearance between adjacent ones of the protrusion portions 11 in the line direction may be different from that in the column direction. The length of a clearance between adjacent ones of the protrusion portions 11 may be, for example, about one third of the width of an index finger of an adult, or may be any. For example, the length of a clearance between adjacent ones of the protrusion portions 11 may be defined by experimentally measuring a distance such that the contour of a protrusion portion 11 and the clearance between adjacent ones of the protrusion portions 11 are sensed by using an operator's finger and such that an operator's finger is not caught when the operator slides the finger on the surface of the sensor unit 10a. Thus, without watching the display unit 30, the operator may select any of the protrusion portions 11-n (n is an integer equal to or larger than one and equal to or smaller than the number of protrusion portions 11) by touch.

FIG. 4 is a side view of an exemplary configuration of the sensor unit 10a according to the first embodiment. FIG. 4 is a section view of the sensor unit 10a taken along the line IV illustrated in FIG. 3. The sensor unit 10a is supported by the elastic body 14-1 and the elastic body 14-2. In FIG. 4, the protrusion portions 11 and the planar portion 12 are moved in the z axis as an integral body in response to a pressing operation performed by an operator. The mechanical key 13 detects the pressing operation, and outputs a press signal indicating the position of the detected pressing operation, to an acquiring unit 21.

The section of a protrusion portion 11 has the shape of a slight protrusion having such a height that an operator's finger which is slid is not caught on the protrusion. Hereinafter, a reference position in the x axis direction which is the highest position in the z axis direction in the protrusion portion 11-3 and which is located close to the protrusion portion 11-2 is represented by “L1[0]”. A reference position in the x axis direction which is the highest position in the z axis direction in the protrusion portion 11-2 and which is located close to the protrusion portion 11-3 is represented by “R1[0]”. A reference position in the x axis direction which is the highest position in the z axis direction in the protrusion portion 11-2 and which is located close to the protrusion portion 11-1 is represented by “L1[1]”. A reference position in the x axis direction which is the highest position in the z axis direction in the protrusion portion 11-1 and which is located close to the protrusion portion 11-2 is represented by “R1[1]”.

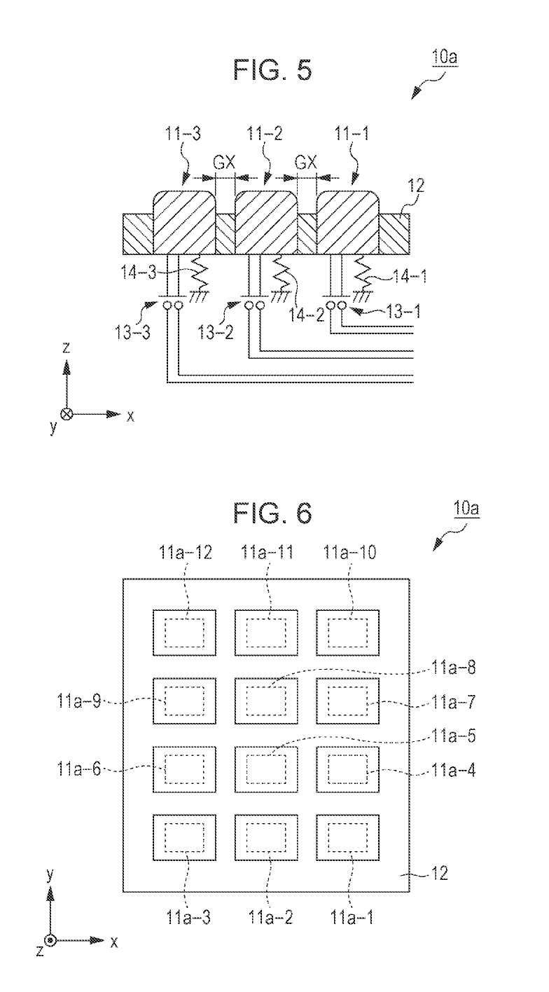

FIG. 5 is a side view of another exemplary configuration of the sensor unit 10a according to the first embodiment. FIG. 5 is also a section view of the sensor unit 10a taken along the line V in FIG. 3. FIG. 5 is different from FIG. 4 in that the protrusion portions 11 are physical keys. That is, in FIG. 5, only a protrusion portion 11 moves in the z axis direction in response to a pressing operation performed by an operator while the planar portion 12 does not move. A mechanical key 13-n detects the pressing operation performed on the protrusion portion 11-n, and outputs a press signal indicating the position of the detected pressing operation to the acquiring unit 21.

Referring back to FIG. 1, the description about the exemplary configuration of the operation system 1 will be continued. The controller 20 performs a predetermined process on the basis of the position signal indicating the position of a contact body which is detected by the sensor unit 10a. The controller 20 includes the acquiring unit 21, a storage unit 22, and a selecting unit 23.

The acquiring unit 21 acquires the position signal indicating the detected position of the contact body from the protrusion portions 11 and the planar portion 12. The position signal may include information indicating the presence or the absence of touching. The acquiring unit 21 acquires the press signal indicating the position of the detected pressing operation from the mechanical key 13.

The storage unit 22 stores shape information indicating the structure with protrusions and depressions on the surface of the sensor unit 10a. For example, the storage unit 22 stores coordinates information indicating the highest position of each of the protrusion portions 11 arranged in a matrix. The storage unit 22 encompasses, for example, a random access memory (RAM) and a read only memory (ROM), a flash memory, a hard disk drive (HDD), and a register.

FIG. 6 is a conceptual diagram illustrating shape information according to the first embodiment. A position 11a-n indicates the highest height position of the protrusion portion 11-n, and is indicated by using a dashed line in FIG. 6. The coordinates information indicating the position 11a-n is, for example, a group of coordinates represented in the xy coordinates.

The selecting unit 23 is a software function unit which functions, for example, with a processor such as a central processing unit (CPU) executing programs stored in the storage unit 22. The selecting unit 23 may be a hardware function unit, such as a large scale integration (LSI) or an application specific integrated circuit (ASIC).

The selecting unit 23 performs a predetermined process on the basis of the position signal indicating the position of the contact body which is detected by the sensor unit 10a. The position signal is, for example, represented by using coordinates on the surface of the sensor unit 10a. For example, when the position of the contact body is moved from a position other than the protrusion portions 11 to that in a protrusion portion 11, the selecting unit 23 switches selection of an operation key image displayed on the display unit 30, at a criterion position determined based on the highest position of the protrusion portion 11. For example, the criterion position is a position the contact body reaches after passing through the highest position.

The selecting unit 23 causes the display unit 30 to display a cursor image on the selected operation key image at the position of the selected operation key image. An operator may grasp the selected operation key image on the basis of the position of the cursor image.

The display unit 30 displays an operation image for operating electronic equipment. The display unit 30 is installed, for example, on the instrument panel of a vehicle, and is also used as a display unit of a navigation apparatus or the like. The operation image is an image including multiple operation key images. For example, the operation image is a character input keyboard image for character input, or a process-selection keyboard image for selecting a process or the like to be executed by the electronic equipment.

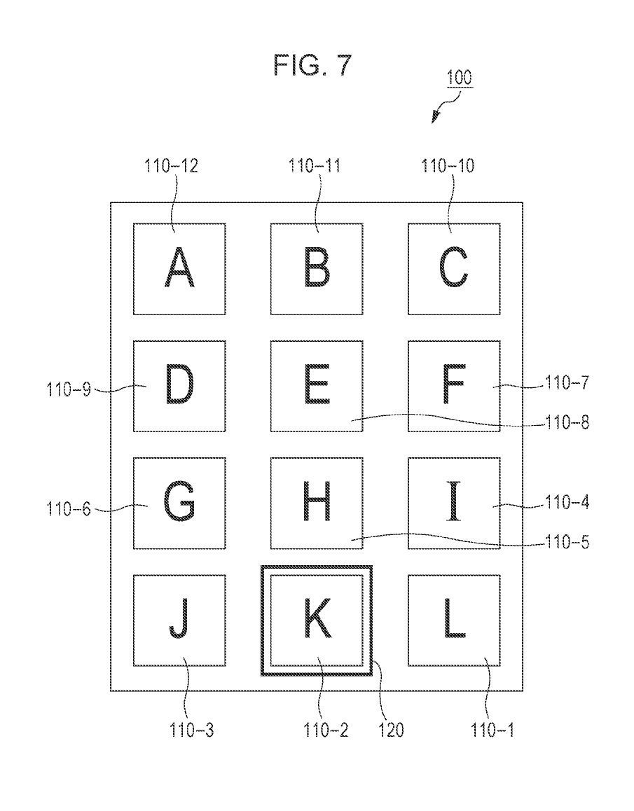

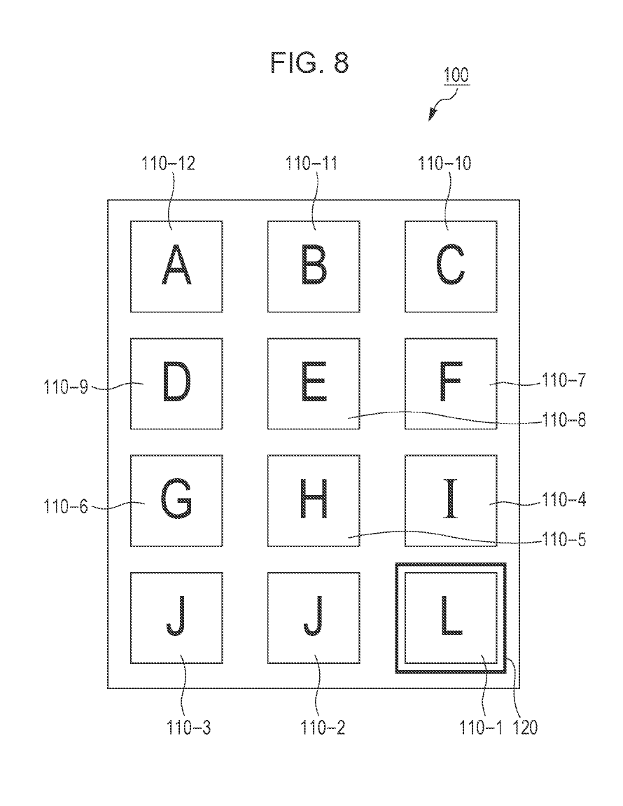

FIG. 7 is a diagram illustrating an example of a character input keyboard image 100 and a cursor image 120 according to the first embodiment. The character input keyboard image 100 includes operation key images 110-1 to 110-12 arranged in a 4×3 matrix. In FIGS. 7 and 8, the position signal is represented, for example, by using absolute coordinates on the surface of the sensor unit 10a. When the position signal is represented by using absolute coordinates, the protrusion portions 11-n correspond to the operation key images 110-n displayed on the display unit 30 in a one-to-one relationship.

When an operator touches the protrusion portion 11-2 on the sensor unit 10a, the selecting unit 23 selects the operation key image 110-2 corresponding to the protrusion portion 11-2 on the basis of the position signal. The selecting unit 23 causes the display unit 30 to display the cursor image 120 on the selected operation key image 110-2 at the position of the selected operation key image 110-2. When the position signal is represented by using absolute coordinates, the cursor image 120 is displayed only during a period in which an operator's finger touches the surface of the sensor unit 10a or during a period in which an operator's finger is located close to the surface of the sensor unit 10a.

FIG. 8 is a diagram illustrating an example of the cursor image 120 which has moved, according to the first embodiment. Subsequent to the case in FIG. 7, when the operator performs a slide operation so as to touch the protrusion portion 11-1 on the sensor unit 10a, the selecting unit 23 selects the operation key image 110-1 corresponding to the protrusion portion 11-1 on the basis of a change in the position signal. When the operation key image 110-1 is selected, the selecting unit 23 causes the display unit 30 to display the cursor image 120 on the selected operation key image 110-1 at the position of the selected operation key image 110-1. In this state, when the operator performs a pressing operation with his/her finger, a predetermined process corresponding to the selected operation key image 110-1 on which the cursor image 120 is displayed is performed.

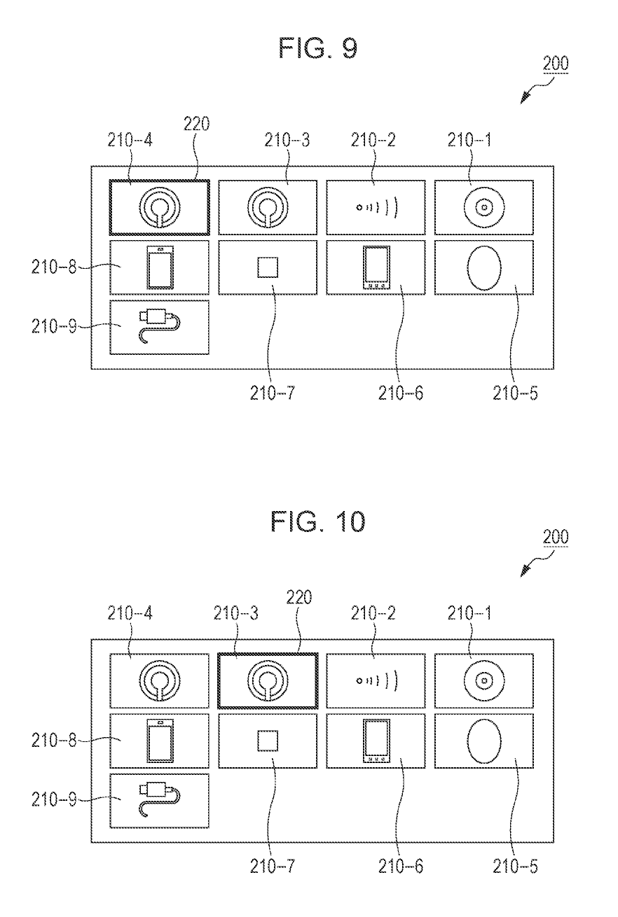

FIG. 9 is a diagram illustrating an example of a process-selection keyboard image 200 and a cursor image 220 according to the first embodiment. The process-selection keyboard image 200 includes operation key images 210-1 to 210-9 arrayed in a 3×4 matrix. A part of the area of the 3×4 matrix may include an area to which no operation key images 210 are assigned. In FIGS. 9 and 10, the position signal is represented by using relative coordinates on the surface of the sensor unit 10a. When the position signal is represented by using relative coordinates, the protrusion portions 11-n do not have to correspond to the operation key images 210-n displayed on the display unit 30 in a one-to-one relationship.

When an operator touches the protrusion portion 11-2 on the sensor unit 10a, the selecting unit 23 selects the operation key image 210-4 on the basis of the position signal as an example of the initial state. The selecting unit 23 causes the display unit 30 to display the cursor image 220 on the selected operation key image 210-4 at the position of the selected operation key image 210-4. In the case where the position signal is represented by using relative coordinates, the cursor image 120 is displayed even when an operator's finger (contact body) does not touch the surface of the sensor unit 10a. When an operator releases his/her finger from the surface of the sensor unit 10a, then touches the surface again with his/her finger, and moves the finger while sliding the finger on the surface of the sensor unit 10a, the cursor image 120 moves from the position at which the cursor image 120 was displayed.

FIG. 10 is a diagram illustrating an example of the cursor image 220 which has moved, according to the first embodiment. Subsequent to the case in FIG. 9, when the operator performs a slide operation to touch the protrusion portion 11-1 on the sensor unit 10a, the selecting unit 23 selects the operation key image 210-3 which is located at a position whose distance from the operation key image 210-4 is a predetermined distance in the same direction as the direction in which the finger has moved, on the basis of the position signal which has changed in accordance with the relative coordinates from the protrusion portion 11-2 to the protrusion portion 11-1.

When the operation key image 210-3 is selected on the basis of the change in the position signal, the selecting unit 23 causes the display unit 30 to display the cursor image 220 on the selected operation key image 210-3 at the position of the selected operation key image 210-3. In this state, when the operator performs a pressing operation, a predetermined process which corresponds to the selected operation key image 210-3 on which the cursor image 220 is displayed is performed.

As illustrated in FIG. 2, a finger with which the operator performs a slide operation is caught on a protrusion portion 11 on the sensor unit 10a.

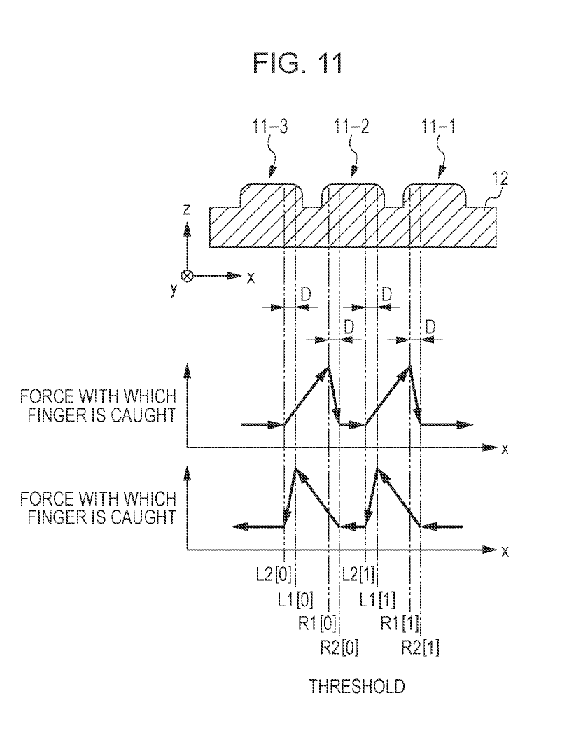

FIG. 11 is a diagram illustrating an exemplary relationship between a force with which a finger is caught and a threshold according to the first embodiment. The top is a side view of the sensor unit 10a illustrated in FIG. 4. The middle is a diagram illustrating a change in the force with which a finger with which a slide operation is performed in the positive direction of the x axis is caught on a protrusion portion 11 on the sensor unit 10a. The bottom is a diagram illustrating a change in the force with which a finger with which a slide operation is performed in the negative direction of the x axis is caught on a protrusion portion 11 on the sensor unit 10a.

Hereinafter, a position whose distance from the reference position L1[0] is a distance D in the direction away from the protrusion portion 11-2 (the negative direction of the x axis) is denoted by “L2[0]”. A position whose distance from the reference position R1[0] is the distance D in the direction away from the protrusion portion 11-3 (the positive direction of the x axis) is denoted by “R2[0]”. A position whose distance from the reference position L1[1] is the distance D in the direction away from the protrusion portion 11-1 (the negative direction of the x axis) is denoted by “L2[1]”. A position whose distance from the reference position R1[1] is the distance D in the direction away from the protrusion portion 11-2 (the positive direction of the x axis) is denoted by “R2[1]”.

If the timing at which an operator's finger is caught at the highest position of a protrusion portion 11 is in synchronization with the timing at which the operation system 1 switches selection of an operation key image 110 or the like, the operability of the operation system 1 is improved. The selecting unit 23 determines the position which functions as a threshold for switching selection of an operation key image 110 or the like, on the basis of the shape information (see FIG. 6) so that the timing at which an operator's finger is caught at the highest position of a protrusion portion 11 is in synchronization with the timing at which the selecting unit 23 switches selection of an operation key image 110 or the like.

The highest position of a protrusion portion 11 at which an operator's finger is to be caught differs between the case in which the operator's finger moves in the positive direction of the x axis and the case in which the operator's finger moves in the negative direction of the x axis. Thus, the selecting unit 23 determines a threshold for switching selection of an operation key image 110 or the like, for each direction in which an operator's finger moves.

The reference position R1[0] and the reference position R1[1] are positions which function as a threshold compared by the selecting unit 23 to switch selection of an operation key image 110 or the like when a continuous change in the position signal indicating the position of the contact body indicates that the operator's finger moves in the positive direction of the x axis. In contrast, the reference position L1[0] and the reference position L1[1] are positions which function as a threshold used to switch selection of an operation key image 110 or the like when a continuous change in the position signal indicating the position of the contact body indicates that the contact body moves in the negative direction of the x axis.

The threshold compared by the selecting unit 23 to switch selection of an operation key image 110 or the like may be determined so that the threshold matches the highest position of an protrusion portion 11, or may be determined so that the threshold matches a position ahead of the highest height position where a finger reaches after having passed through the highest position of a protrusion portion 11. The position R2[0] is located away from the reference position R1[0] by the distance D in the positive direction of the x axis. A position in the range between the reference position R1[0] and the position R2[0] is a position which functions as a threshold compared by the selecting unit 23 to switch selection of an operation key image 110 or the like in the case where a continuous change in the position signal indicating the position of the contact body indicates that the operator's finger moves in the positive direction of the x axis and where the operator's finger has passed through the position R1[0].

The position R2[1] is located away from the reference position R1[1] by the distance D in the positive direction of the x axis. A position in the range between the reference position R1[1] and the position R2[1] is a position which functions as a threshold compared by the selecting unit 23 to switch selection of an operation key image 110 or the like in the case where a continuous change in the position signal indicating the position of the contact body indicates that the operator's finger moves in the positive direction of the x axis and where the operator's finger has passed through the position R1[1].

The position L2[0] is located away from the reference position L1[0] by the distance D in the negative direction of the x axis. A position in the range between the reference position L1[0] and the position L2[0] is a position which functions as a threshold compared by the selecting unit 23 to switch selection of an operation key image 110 or the like in the case where a continuous change in the position signal indicating the position of the contact body indicates that the operator's finger moves in the negative direction of the x axis and where the operator's finger has passed through the position L1[0].

The position L2[1] is located away from the reference position L1[1] by the distance D in the negative direction of the x axis. A position in the range between the reference position L1[1] and the position L2[1] is a position which functions as a threshold compared by the selecting unit 23 to switch selection of an operation key image 110 or the like in the case where a continuous change in the position signal indicating the position of the contact body indicates that the operator's finger moves in the negative direction of the x axis and where the operator's finger has passed through the position L1[1].

The distance D which is a distance equal to or larger than zero is experimentally obtained so that, for example, the selecting unit 23 which switches selection of an operation key image 110 or the like does not make an erroneous determination. When the distance D is zero, the position L2[i] (i is an integer equal to or larger than zero) matches the reference position L1[i], and the position R2[i] matches the reference position R1[i].

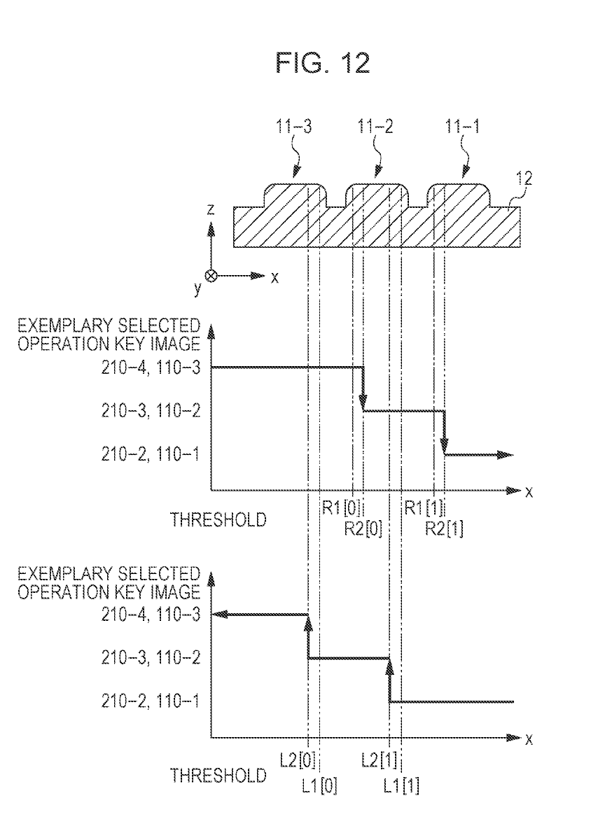

FIG. 12 is a diagram illustrating an exemplary relationship between a selected operation key image 110 or the like and a threshold, according to the first embodiment. The top is a side view of the sensor unit 10a illustrated in FIG. 4. The middle is a diagram illustrating exemplary operation key images 110 or the like which are selected when an operator performs a slide operation in the positive direction of the x axis. The bottom is a diagram illustrating exemplary operation key images 110 or the like which are selected when an operator performs a slide operation in the negative direction of the x axis.

The selecting unit 23 obtains shape information indicating the structure with protrusions and depressions on the surface of the sensor unit 10a from the storage unit 22. The coordinates information indicating each of the reference position L1[0], the position L2[0], the reference position L1[1], the position L2[1], the reference position R1[0], the position R2[0], the reference position R1[1], and the position R2[1] which are illustrated in FIG. 12 is read from the shape information (see FIG. 6) as information indicating a threshold.

The selecting unit 23 determines the direction in which the contact body moves on the basis of a continuous change in the position signal. In a state in which the operation key image 110-3 is selected because the position of the contact body is located in the negative direction of the x axis relative to the position R1[0], when the contact body moves in the positive direction of the x axis, the selecting unit 23 compares the positions R1[0] and R2[0] with the position of the contact body. The selecting unit 23 switches selection to the operation key image 110-2 at the timing at which the position of the contact body has passed through the position R1[0] and reaches or passes through the position R2[0]. The selecting unit 23 causes the display unit 30 to display the cursor image 120 on the selected operation key image 110-2 at the position of the selected operation key image 110-2. That is, the selecting unit 23 moves the cursor image 120 to the position of the operation key image 110-2 (for example, see FIG. 7) at the timing at which the force with which the finger is caught goes down (for example, see FIG. 11).

In this state, when the contact body further moves in the positive direction of the x axis, the selecting unit 23 compares the positions R1[1] and R2[1] with the position of the contact body. The selecting unit 23 switches selection to the operation key image 110-1 at the timing at which the position of the contact body has passed through the position R1[1] and reaches or passes through the position R2[1]. The selecting unit 23 causes the display unit 30 to display the cursor image 120 on the selected operation key image 110-1 at the position of the selected operation key image 110-1. That is, the selecting unit 23 moves the cursor image 120 to the position of the operation key image 110-1 (for example, see FIG. 8) at the timing at which the force with which the finger is caught goes down (for example, see FIG. 11).

That is, the operator senses the force with which the finger is caught, when or after, in the slide operation, the finger passes through the reference position R1[i]. For example, the reference position R1[i] is set to the position at which the force with which an operator's finger is caught is maximum.

The position R2[i] is set to a position at which the finger passes after the operator senses the force with which the finger is caught.

After the finger passes through the reference position R1[i], when the finger passes though the position R2[i], the selecting unit 23 switches selection of an operation key image 210. The same is true for the reference position L1[i] and the position L2[i]. When the position signal is represented by using absolute coordinates, the selecting unit 23 may switch selection of an operation key image 210 even after the finger has passed through the reference position R1[i], when the finger has not passed through the position R2[i].

The determination process performed when the selecting unit 23 is to select an operation key image 210 is similar to the determination process performed when the selecting unit 23 is select an operation key image 110. In FIG. 12, for example, the operation key image 110-3 may be replaced with the operation key image 210-4; the operation key image 110-2, with the operation key image 210-3; and the operation key image 110-1, with the operation key image 210-2. The determination process for the column direction (the y axis direction) which is performed when the selecting unit 23 is to select an operation key image 110 or the like is similar to that in the line direction.

The processes described above enable the timing at which an operator's finger is caught at the highest position of a protrusion portion 11 to be in synchronization with the timing at which the operation system 1 switches selection of an operation key image 110 or the like, enabling operability of the operation system 1 to be improved. For example, in FIG. 12, the position to switch the selection by the selecting unit 23 is different between rightward moving transition and leftward moving transition. It would be apparent by comparing the middle chart and the bottom chart in FIG. 12.

A state transition of the operation system 1 will be described.

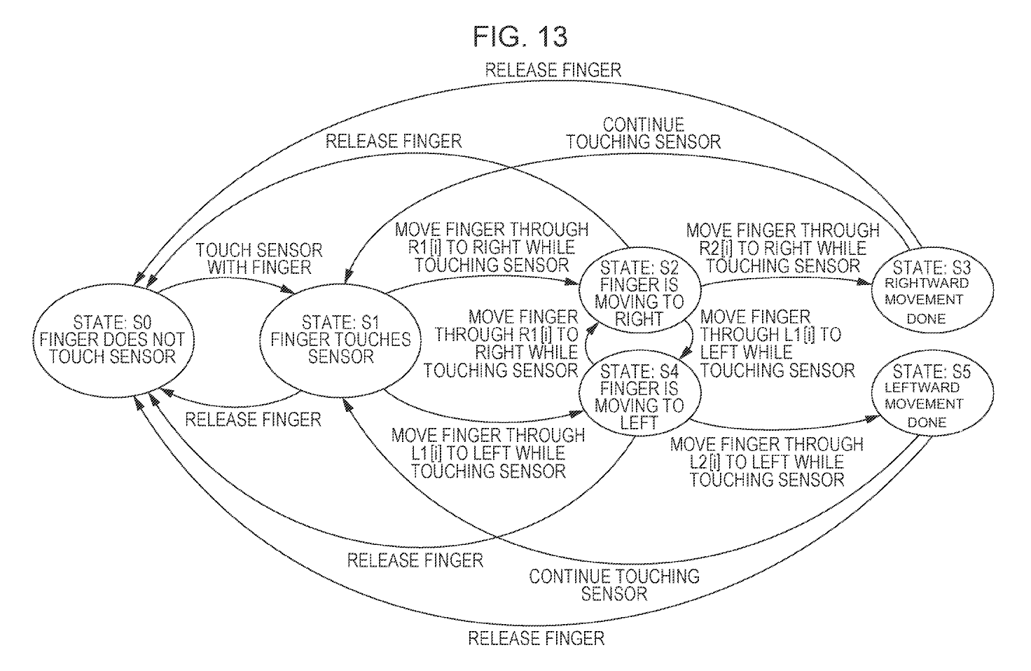

FIG. 13 is a state transition diagram of the operation system 1 according to the first embodiment. The state transition diagram illustrated in FIG. 13 is a state transition diagram for the line direction (the x axis direction) in a determination process in the case where an operation key image 110 or the like is selected. A state transition diagram for the column direction (the y axis direction) is similar to that for the line direction (the x axis direction). In FIG. 13, the positive direction of the x axis is represented by “right”, and the negative direction of the x axis direction is represented by “left”.

States of the operation system 1 include states S0 to S5. The state S0 is a state in which a finger as a contact body does not touch (is released from) the surface of the sensor unit 10a. The state S1 is a state in which a finger as a contact body touches the surface of the sensor unit 10a and moves to neither of the left nor the right.

The state S2 is a state in which a finger as a contact body touches the surface of the sensor unit 10a and is moving to the right. The state S3 is a state in which a finger as a contact body touches the surface of the sensor unit 10a and has moved to the right. The selecting unit 23 moves the cursor image 120 or the like to the right at the timing of a transition to the state S3. The state S4 is a state in which a finger as a contact body touches the surface of the sensor unit 10a and is moving to the left. The state S5 is a state in which a finger as a contact body touches the surface of the sensor unit 10a and has moved to the left. The selecting unit 23 moves the cursor image 120 or the like to the left at the timing of a transition to the state S5.

In the case where the cursor image 120 is displayed on an operation key image 110 located at the end of the character input keyboard image 100, the selecting unit 23 does not have to move the cursor image 120 to an area in which no operation key images 110 are present. The same is true for the process-selection keyboard image 200.

When an operator touches the surface of the sensor unit 10a with his/her finger in the state S0, the operation system 1 makes a transition to the state S1. When the operator releases his/her finger from the surface of the sensor unit 10a in state S1, the operation system 1 makes a transition to the state S0. When the operator moves his/her finger through R1[i] to the right while touching the surface of the sensor unit 10a with his/her finger in the state S1, the operation system 1 makes a transition to the state S2. When the operator moves his/her finger through L1[i] to the left while touching the surface of the sensor unit 10a with his/her finger in the state S1, the operation system 1 makes a transition to the state S4.

When the operator moves his/her finger through R2[i] to the right while touching the surface of the sensor unit 10a with his/her finger in the state S2, the operation system 1 makes a transition to the state S3. When the operator moves his/her finger through L1[i] to the left while touching the surface of the sensor unit 10a with his/her finger in the state S2, the operation system 1 makes a transition to the state S4. When the operator releases his/her finger from the surface of the sensor unit 10a in the state S2, the operation system 1 makes a transition to the state S0.

When the operator continues touching the surface of the sensor unit 10a with his/her finger in the state S3, the operation system 1 makes a transition to the state S1. When the operator releases his/her finger from the surface of the sensor unit 10a in the state S3, the operation system 1 makes a transition to the state S0.

When the operator moves his/her finger through R1[i] to the right while touching the surface of the sensor unit 10a with his/her finger in the state S4, the operation system 1 makes a transition to the state S2. When the operator moves his/her finger through L2[i] to the left while touching the surface of the sensor unit 10a with his/her finger in the state S4, the operation system 1 makes a transition to the state S5. When the operator releases his/her finger from the surface of the sensor unit 10a in the state S4, the operation system 1 makes a transition to the state S0.

When the operator continues touching the surface of the sensor unit 10a with his/her finger in the state S5, the operation system 1 makes a transition to the state S1. When the operator releases his/her finger from the surface of the sensor unit 10a in the state S5, the operation system 1 makes a transition to the state S0.

As described above, the operation system 1 includes the sensor unit 10a, the display unit 30, and the selecting unit 23. The sensor unit 10a which has a structure with protrusions and depressions on the surface thereof detects a position at which a contact body (for example, an operator's finger) touches the surface, and outputs a position signal indicating the detected position of the contact body. The display unit 30 displays an image which corresponds to the surface of the sensor unit 10a and which includes the multiple operation key images 110-1 to 110-12. The selecting unit 23 selects an operation key image 110-n corresponding to the position of the contact body from the multiple operation key images 110-1 to 110-12 displayed on the display unit 30. The selecting unit 23 causes the position of the contact body for switching selection of an operation key image 110-n to differ between the case in which a continuous change in the position signal indicates a first direction and the case in which the continuous change in the position signal indicates a second direction which is opposite to the first direction.

By using this configuration, the selecting unit 23 causes the position of the contact body for switching selection of an operation key image 110-n to differ between the case in which a continuous change in the position signal indicates the first direction and the case in which the continuous change in the position signal indicates the second direction which is opposite to the first direction. Thus, the operation system 1 according to the first embodiment achieves improved operability.

That is, the selecting unit 23 uses a clearance between adjacent operation key images 110 as a hysteresis area when an operation key image 110 is to be selected on the basis of the position signal (coordinates information) obtained from the sensor unit 10a. When an operator performs a slide operation on the protrusion portions 11 arranged in a matrix, the hysteresis area causes a screen transition such as movement of a cursor image to be linked to a moment at which his/her finger goes up to an adjacent protrusion portion 11 key. Thus, the operation system 1 according to the first embodiment achieves improved operability. In the operation system 1 according to the first embodiment, an operator can perform a sure operation and an input operation having a high degree of freedom, such as both of an operation of selecting an operation key image and an operation of inputting coordinates by performing a slide operation on the protrusion portions 11. Without watching the screen of the display unit 30, an operator can perform an operation easy to understand compared with that through feedback of the sense of touch. The operation system 1 according to the first embodiment does not need an expensive actuator. The operation system 1 according to the first embodiment may improve operability obtained during touch typing.

The sensor unit 10a has a structure in which the protrusion portions 11 are arranged in a matrix, on the surface thereof. In the case where a continuous change in the position signal indicates the direction from the protrusion portion 11-2 to the protrusion portion 11-1, even when the position signal indicates a predetermined area of the protrusion portion 11-1 (for example, the area from R1[1] to a position just before R2[1]), the selecting unit 23 has still selected the operation key image 110-n which was selected when the position signal indicated the protrusion portion 11-2. In the case where a continuous change in the position signal indicates the direction from the protrusion portion 11-1 to the protrusion portion 11-2, even when the position signal indicates a predetermined area of the protrusion portion 11-2 (for example, the area from L1[1] to a position just before L2[1]), the selecting unit 23 has still selected the operation key image 110-n which was selected when the position signal indicated the protrusion portion 11-1.

When the position of a finger is moved from a position other than the protrusion portions 11 (such as a depression portion or the planar portion 12) to a protrusion portion 11, the selecting unit 23 switches selection of an operation key image 110-n or the like at a position (for example, R2[1]) based on the highest position of the protrusion portion 11 (for example, R1[1]).

When the position of a finger is moved from a position other than the protrusion portions 11 to a protrusion portion 11, the selecting unit 23 switches selection of an operation key image 110-n or the like at a position reached (for example, R2[1]) after the finger passes through the highest position of the protrusion portion 11 (for example, R1[1]).

In the sensor unit 10a, a clearance between adjacent ones of the protrusion portions 11 in the line direction may be different from that in the column direction.

The sensor unit 10a is capable of detecting a pressing operation performed on at least a part of the surface thereof. When the sensor unit 10a detects a pressing operation, the selecting unit 23 performs a process corresponding to the operation key image 110-n selected as an operation key image 110 corresponding to the position of a finger.

### Second Embodiment

A second embodiment is different from the first embodiment in that the number of protrusion portions 11 is more than that of operation key images 210. In the second embodiment, only differences between the first and second embodiments will be described.

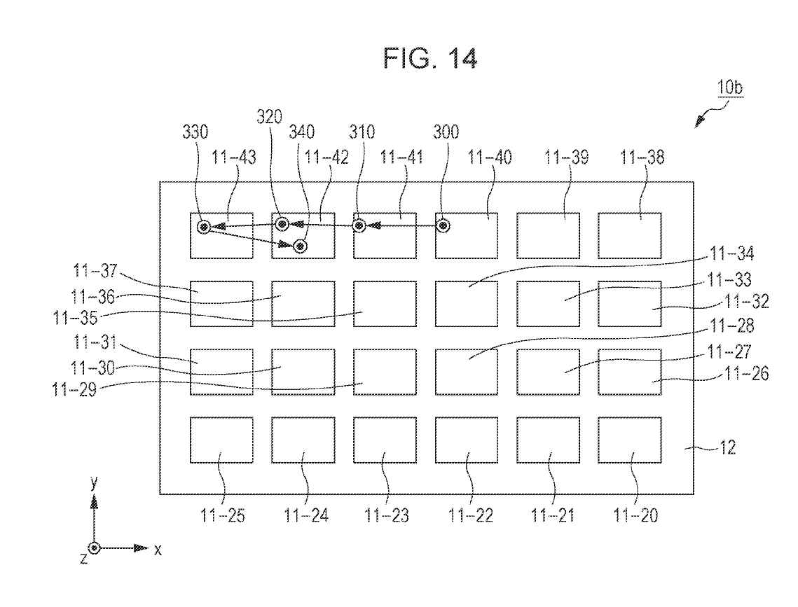

FIG. 14 is a front view of an exemplary configuration of a sensor unit 10b according to the second embodiment. The sensor unit 10b includes the protrusion portions 11-20 to 11-43 arranged in a matrix and the planar portion 12, as a structure with protrusions and depressions, on the surface thereof. In FIG. 14, the protrusion portions 11 are, for example, arranged in a 4×6 matrix. The protrusion portions 11 may be depression portions.

In FIG. 14, the number of protrusion portions 11 is more than that of operation key images 210. Therefore, the position signal may be represented by using relative coordinates on the surface of the sensor unit 10b. An operator performs a slide operation on the surface of the sensor unit 10b, whereby the position of a contact body which is indicated by the position signal is changed, for example, to a contact-body position 300, a contact-body position 310, a contact-body position 320, a contact-body position 330, and a contact-body position 340 in this sequence. The contact-body position 300 is located in the protrusion portion 11-40. The contact-body position 310 is located in the protrusion portion 11-41. The contact-body position 320 is located in the protrusion portion 11-42. The contact-body position 330 is located in the protrusion portion 11-43. The contact-body position 340 is located in the protrusion portion 11-42.

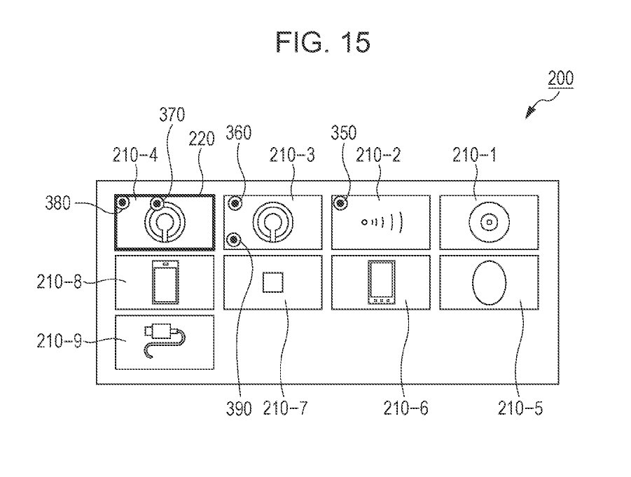

FIG. 15 is a diagram illustrating exemplary corresponding positions corresponding to the contact-body positions according to the second embodiment. A corresponding position 350 is a position corresponding to the contact-body position 300 illustrated in FIG. 14 in the process-selection keyboard image 200. A corresponding position 360 is a position corresponding to the contact-body position 310 illustrated in FIG. 14 in the process-selection keyboard image 200. A corresponding position 370 is a position corresponding to the contact-body position 320 illustrated in FIG. 14 in the process-selection keyboard image 200.

A corresponding position 380 is a position corresponding to the contact-body position 330 illustrated in FIG. 14 in the process-selection keyboard image 200. Even when the amount of a change in relative coordinates from the contact-body position 320 to the contact-body position 330 is large, the selecting unit 23 still displays the cursor image 220 at the position of the operation key image 210-4 because the corresponding position 380 already reaches the end of the process-selection keyboard image 200.

A corresponding position 390 is a position corresponding to the contact-body position 340 illustrated in FIG. 14 in the process-selection keyboard image 200. The selecting unit 23 moves the cursor image 220 to the position of the operation key image 210-3 on the basis of the amount of a change in relative coordinates from the contact-body position 330 to the contact-body position 340.

As described above, the sensor unit 10b has the protrusion portions 11, the number of which is more than that of operation key images 210 or the like displayed on the display unit 30. In the case where the cursor image 220 or the like already reaches the end of the operation image, even when the amount of a change in the position of a contact body is large, this configuration enables the selecting unit 23 not to move the cursor image 220 or the like.

### Third Embodiment

A third embodiment is different from the first and second embodiments in that an optical sensor detects the position of a contact body. In the third embodiment, differences between the first or second embodiment and the third embodiment will be described.

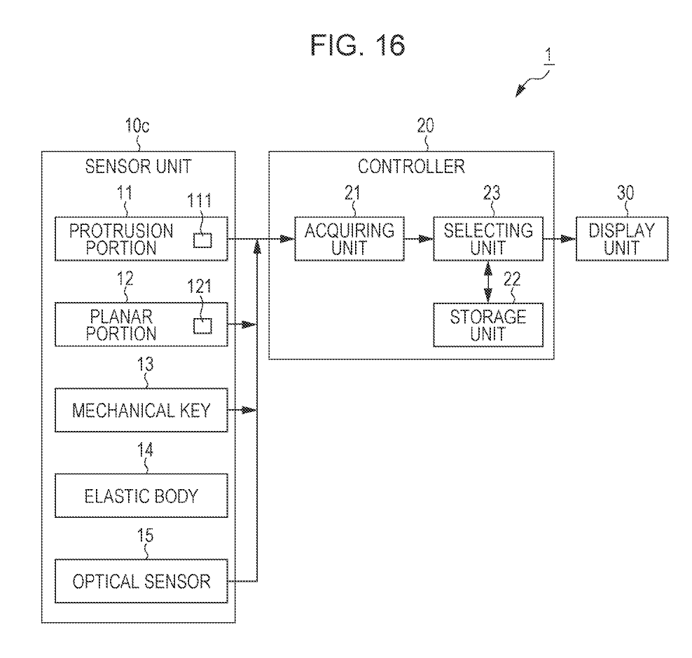

FIG. 16 is a diagram illustrating an exemplary configuration of the operation system 1 according to the third embodiment. The operation system 1 includes a sensor unit 10c, the controller 20, and the display unit 30. Compared with the sensor unit 10a according to the first embodiment, the sensor unit 10c further includes optical sensors 15. The optical sensors 15 emit light beams such as infrared rays in predetermined directions, and detect the position of a contact body such as an operator's finger on the basis of the position at which light beams are cut off.

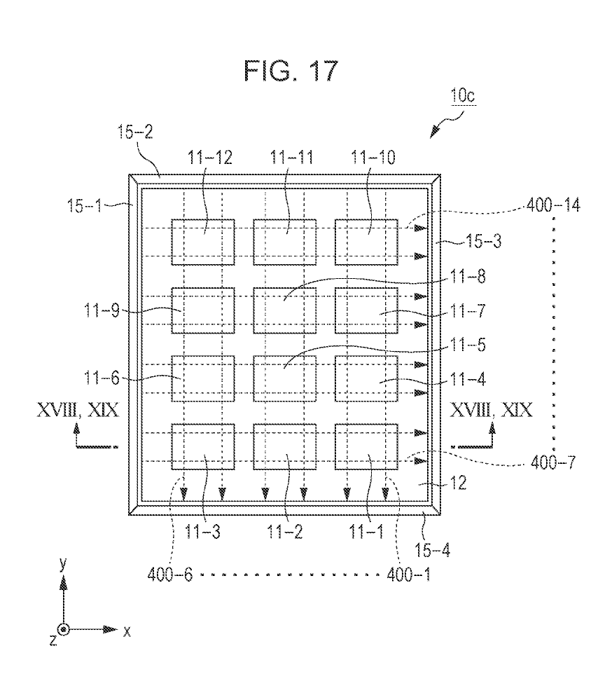

FIG. 17 is a front view of an exemplary configuration of the sensor unit 10c according to the third embodiment. The optical sensors 15 are disposed in such a manner as to surround the sensor unit 10c. In FIG. 17, the optical sensor 15-1 and the optical sensor 15-3 are disposed so as to face each other. The optical sensor 15-2 and the optical sensor 15-4 are disposed so as to face each other.

An optical sensor 15 emits light beams 400 such as infrared rays to another optical sensor 15 located at an opposite position. The light beams 400 are emitted so as to cover the surface of the sensor unit 10c. An optical sensor 15 receives the light beams 400 emitted from another optical sensor 15 located at an opposite position. The optical sensors 15 detect the position of a contact body such as an operator's finger on the basis of the position at which light beams 400 are cut off. The optical sensors 15 output a position signal indicating the detected position of a contact body to the controller 20.

For example, the optical sensor 15-2 emits the light beams 400 such as infrared rays to the optical sensor 15-4 located at an opposite position. The light beams 400-1 to 400-6 are emitted so as to cover the surface of the sensor unit 10c. The optical sensor 15-4 receives the light beams 400-1 to 400-6 emitted from the optical sensor 15-2 located at an opposite position. The optical sensor 15-4 detects the position of a contact body such as an operator's finger on the basis of which beam among the light beams 400-1 to 400-6 is cut off in the x axis direction. The optical sensor 15-4 outputs a position signal indicating the detected position of the contact body to the controller 20. Similarly, in the y axis direction, the optical sensor 15-3 detects the position of a contact body such as an operator's finger on the basis of which beam among the light beams 400-7 to 400-14 is cut off.

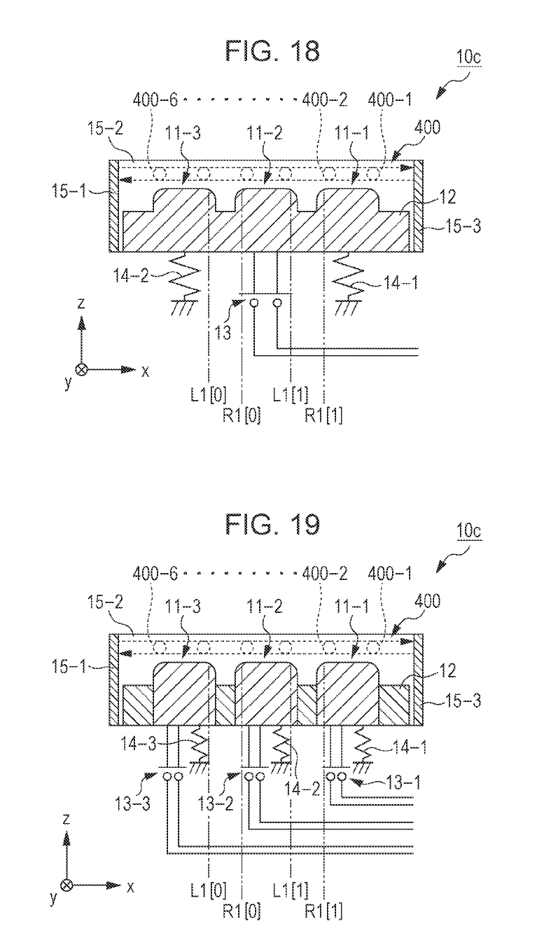

FIG. 18 is a side view of an exemplary configuration of the sensor unit 10c according to the third embodiment. For example, the optical sensor 15-2 emits the light beams 400-1 to 400-6 to the optical sensor 15-4 (see FIG. 17) located at an opposite position. The optical sensor 15-4 receives the light beams 400-1 to 400-6 emitted from the optical sensor 15-2 located at an opposite position. For example, when the light beam 400-2 is cut off, the optical sensor 15-4 outputs a position signal indicating the position R1[1] at which the light beam 400-2 is cut off, as a position signal indicating the detected position of a contact body to the controller 20.

FIG. 19 is a side view of another exemplary configuration of the sensor unit 10c according to the third embodiment. FIG. 19 is different from FIG. 18 in that the protrusion portions 11 are physical keys. That is, in FIG. 19, only a protrusion portion 11 moves in the z axis direction in response to a pressing operation performed by an operator while the planar portion 12 does not move. A mechanical key 13-n detects a pressing operation performed on the protrusion portion 11-n, and outputs a press signal indicating the position at which the pressing operation is detected, to the acquiring unit 21. The optical sensors 15 are capable of detecting the position at which a protrusion portion 11 is pressed, with accuracy higher than that for a mechanical key 13-n. That is, the optical sensors 15 are capable of detecting a portion of a protrusion portion 11 which has been pressed. For example, when the light beam 400-2 is cut off, the optical sensor 15-4 outputs a position signal indicating the position R1[1] at which the light beam 400-2 is cut off, as a position signal indicating the position at which a pressing operation is performed by using a contact body, to the controller 20.

The embodiments of the present disclosure are described. The present disclosure is not limited to these embodiments. Without departing from the gist of the present disclosure, various changes and substitutions may be made.

For example, the operation system 1 according to the present embodiments is not limited to one mounted on a vehicle, and may be applied to electronic equipment which detects touching, such as a cellular phone or a tablet terminal.

For example, the operation system 1 according to the present embodiments may be combined with a touch screen, an arrow key, a joystick, a toggle switch, a dial switch, and the like.

For example the selecting unit 23 according to the present embodiments may scroll an operation image or a map image displayed on the display unit 30 on the basis of a position signal indicating the position of a contact body detected by the sensor unit 10a. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

What is claimed is:

1. An operation system comprising:
a sensor unit having a structure with protrusions or depressions on a surface thereof, the sensor unit detecting a position at which a contact body touches the surface and outputting a position signal indicating the detected position of the contact body;
a display unit that displays an image corresponding to the surface of the sensor unit and including a plurality of operation key images; and
a selecting unit that selects, corresponding to the position of the contact body, an operation key image from the plurality of operation key images displayed on the display unit,
wherein the position of the contact body at which the selected operation key image is switched differs between a case in which a continuous change in the position signal indicates a first direction and a case in which the continuous change in the position signal indicates a second direction which is opposite to the first direction.

2. The operation system according to claim 1,
wherein the sensor unit has a structure in which protrusion portions are arranged in a matrix on the surface, and
wherein, in the case where the continuous change in the position signal indicates a direction from a first protrusion portion to a second protrusion portion among the protrusion portions, even when the position signal indicates a predetermined area of the second protrusion portion, the selecting unit continues selecting the operation key image which was selected when the position signal indicated the first protrusion portion, and, in the case where the continuous change in the position signal indicates a direction from the second protrusion portion to the first protrusion portion, even when the position signal indicates the predetermined area of the first protrusion portion, the selecting unit continues selecting the operation key image which was selected when the position signal indicated the second protrusion portion.

3. The operation system according to claim 2,
wherein, when the position of the contact body is moved to one of the protrusion portions from a position other than the protrusion portions, the selecting unit switches selection of the operation key image at a position determined by using, as a reference point, the highest height position in the predetermined area of the protrusion portion.

4. The operation system according to claim 3,
wherein, when the position of the contact body is moved to the one of the protrusion portions from the position other than the protrusion portions, the selecting unit switches selection of the operation key image at a position ahead of where the contact body has passed through the highest height position in the predetermined area of the protrusion portion.

5. The operation system according to claim 2,
wherein, in the sensor unit, a length of a clearance between adjacent protrusion portions among the protrusion portions differs between a line direction and a column direction.

6. The operation system according to claim 2,
wherein the sensor unit has the protrusion portions, the number of which is more than the number of operation key images displayed on the display unit.

7. The operation system according to claim 1,
wherein the sensor unit is capable of detecting a pressing operation performed on at least a part of the surface, and
wherein, when the sensor unit detects the pressing operation, the selecting unit performs a process corresponding to the operation key image selected as the operation key image corresponding to the position of the contact body.

8. The operation system according to claim 1,
wherein the selecting unit detects a moving direction of the contact body using the continuous change in the position signal.

9. The operation system according to claim 8,
wherein the selecting unit switches from a first operation key image to a second operation key image adjacent to the first operation key image when the moving direction is the first direction, and the selecting unit switches from the second operation key image to the first operation key image when the moving direction is the second direction,
wherein the selecting unit switches from the first operation key image to the second operation key image at a time when the detected position of the contact body reaches a first criterion position, and the selecting unit switches from the second operation key image to the first operation key image at a time when the detected position of the contact body reaches a second criterion position, and
the first criterion position is different from the second criterion position.

10. A vehicle comprises the operation system according to claim 1, wherein the sensor unit and the display unit are separately disposed in the vehicle from each other.

11. An operation system comprising:
a sensor having a structure with protrusions or depressions on a surface thereof, the sensor detecting a position at which a contact body touches the surface and outputting a position signal indicating the detected position of the contact body;
a display device that displays an image corresponding to the surface of the sensor and including a plurality of operation key images; and
a controller that selects, corresponding to the position of the contact body, an operation key image from the plurality of operation key images displayed on the display device,
wherein the controller detects a moving direction of the contact body using a continuous change in the position signal, and
wherein the position of the contact body at which the selected operation key image is switched differs between a case in which the continuous change in the position signal indicates a first direction and a case in which the continuous change in the position signal indicates a second direction which is opposite to the first direction.

12. The operation system according to claim 11,
wherein the sensor has a structure in which protrusion portions are arranged in a matrix on the surface, and wherein, in the case where the continuous change in the position signal indicates a direction from a first protrusion portion to a second protrusion portion among the protrusion portions, even when the position signal indicates a predetermined area of the second protrusion portion, the controller continues selecting the operation key image which was selected when the position signal indicated the first protrusion portion, and, in the case where the continuous change in the position signal indicates a direction from the second protrusion portion to the first protrusion portion, even when the position signal indicates the predetermined area of the first protrusion portion, the controller continues selecting the operation key image which was selected when the position signal indicated the second protrusion portion.

13. The operation system according to claim 12,
wherein, when the position of the contact body is moved to one of the protrusion portions from a position other than the protrusion portions, the controller switches selection of the operation key image at a position determined by using, as a reference point, the highest height position in the predetermined area of the protrusion portion.

14. The operation system according to claim 13,
wherein, when the position of the contact body is moved to the one of the protrusion portions from the position other than the protrusion portions, the controller switches selection of the operation key image at a position ahead of where the contact body has passed through the highest height position in the predetermined area of the protrusion portion.

15. The operation system according to claim 12,
wherein, in the sensor, a length of a clearance between adjacent protrusion portions among the protrusion portions differs between a line direction and a column direction.

16. The operation system according to claim 12,
wherein the sensor has the protrusion portions, the number of which is more than the number of operation key images displayed on the display device.

17. The operation system according to claim 11,
wherein the sensor is capable of detecting a pressing operation performed on at least a part of the surface, and
wherein, when the sensor detects the pressing operation, the controller performs a process corresponding to the operation key image selected as the operation key image corresponding to the position of the contact body.

18. The operation system according to claim 11,
wherein the controller switches from a first operation key image to a second operation key image adjacent to the first operation key image when the moving direction is the first direction, and the controller switches from the second operation key image to the first operation key image when the moving direction is the second direction,
wherein the controller switches from the first operation key image to the second operation key image at a time when the detected position of the contact body reaches a first criterion position, and the controller switches from the second operation key image to the first operation key image at a time when the detected position of the contact body reaches a second criterion position, and
the first criterion position is different from the second criterion position.

19. A vehicle comprises the operation system according to claim 11, wherein the sensor and the display device are separately disposed in the vehicle from each other.

20. A method of controlling an operation system including a sensor having a structure with protrusions or depressions on a surface thereof and a display device that displays an image corresponding to the surface of the sensor and including a plurality of operation key images, the method comprising:
detecting, by the sensor, a position at which a contact body touches the surface and outputting a position signal indicating the detected position of the contact body;
selecting, by a computer, corresponding to the position of the contact body, an operation key image from the plurality of operation key images displayed on the display device,
wherein the selecting step includes detecting a moving direction of the contact body using a continuous change in the position signal, and
wherein the position of the contact body at which the selected operation key image is switched differs between a case in which the continuous change in the position signal indicates a first direction and a case in which the continuous change in the position signal indicates a second direction which is opposite to the first direction.
